(19) United States
(12) Patent Application Publication
(10) Pub. No.: US 2016/0163340 A1
(43) Pub. Date: Jun. 9, 2016

(54) MICROWAVE-ASSISTED MAGNETIC HEAD AND MAGNETIC RECORDING/REPRODUCING APPARATUS

(71) Applicant: KABUSHIKI KAISHA TOSHIBA, Tokyo (JP)

(72) Inventors: Naoyuki Narita, Fujisawa Kanagawa (JP); Kenichiro Yamada, Tokyo (JP); Yusuke Tomoda, Zama Kanagawa (JP); Akihiko Takeo, Kokubunji Tokyo (JP)

(21) Appl. No.: 14/639,067

(22) Filed: Mar. 4, 2015

(30) Foreign Application Priority Data
Dec. 9, 2014 (JP) 2014-248705

(51) Int. Cl. G11B 5/48

(52) U.S. Cl. CPC G11B 5/4853; G11B 2005/0024

(57) ABSTRACT

According to one embodiment, a microwave-assisted magnetic head includes a main magnetic pole configured to apply a recording magnetic field to a magnetic recording medium, an auxiliary magnetic pole configured to constitute a magnetic circuit together with the main magnetic pole, and a domain propagation element including a domain propagation path having two ends and a magnetic anisotropy perpendicular to a domain propagation direction, and a domain input portion configured to write a magnetic domain in the domain propagation path, and a current supply mechanism connected to the domain propagation path, and at least part of the domain propagation path passes between the main magnetic pole and the auxiliary magnetic pole.

### CROSS-REFERENCE TO RELATED APPLICATIONS

This application is based upon and claims the benefit of priority from Japanese Patent Application No. 2014-248705, filed Dec. 9, 2014, the entire contents of which are incorporated herein by reference.

### FIELD

Embodiments described herein relate generally to a microwave-assisted magnetic head and a magnetic recording/reproducing apparatus.

### BACKGROUND

A microwave-assisted magnetic recording method has received attention as a recording method that implements a high recording density.

In the microwave-assisted magnetic recording method, a high-frequency magnetic field near the resonance frequency of magnetizations in a magnetic recording medium, which is much higher than the recording signal frequency, is locally applied. As a result, magnetizations in the magnetic recording medium resonate, and the coercive field (Hc) of the magnetic recording medium to which the high-frequency magnetic field is applied decreases to ½ or less of the original coercive field. For this reason, when the high-frequency magnetic field is superimposed on the recording magnetic field, magnetic recording on a magnetic recording medium having a higher coercive field and higher magnetic anisotropy energy (Ku) can be performed.

There is a microwave-assisted magnetic head in which, for example, a spin-torque oscillator including a stacked body of a spin transfer torque layer, a nonmagnetic intermediate layer, and an oscillation layer is formed between a main magnetic pole and an auxiliary magnetic pole. In this method, a frequency of a magnetic field generated from the spin torque oscillator is uncontrollable because it is decided by amplitude of a field applied from the magnetic recording head to the oscillation layer.

Another microwave-assisted magnetic head uses, as a high-frequency magnetic field, an ampere magnetic field generated by supplying a high-frequency current to a conductor line. In this method, it is enable to generate the high-frequency field with the same frequency of the high-frequency current.

However, the current frequency is limited by the skin effect, and it is difficult to optimize an oscillation frequency for exciting magnetizations in a magnetic recording medium with a high efficiency.

### BRIEF DESCRIPTION OF THE DRAWINGS

FIG. 1 is a perspective view showing a schematic structure of a microwave-assisted magnetic head according to an embodiment;

FIG. 2 is a view of the microwave-assisted magnetic head shown in FIG. 1 viewed from the down-track direction;

FIG. 3 is a perspective view showing another example of the schematic structure of the microwave-assisted magnetic head according to the embodiment;

FIG. 4 is a view showing still another example of the schematic structure of the microwave-assisted magnetic head according to the embodiment;

FIG. 5 is a view of the microwave-assisted magnetic head shown in FIG. 4 viewed from the head air bearing surface;

FIG. 6 is a view schematically showing an example of domain input to a domain propagation path;

FIG. 7 is a view schematically showing another example of domain input to the domain propagation path;

FIG. 8 is a view schematically showing an example of a domain propagation element including an element capable of detecting a domain period;

FIG. 9 is a view showing the outline of a domain propagation element used in simulations of the microwave-assisted magnetic head according to the embodiment;

FIG. 10 is a graph showing the in-plane component of the high-frequency magnetic field generated from the domain propagation path when a magnetic period λ is changed; and

FIG. 11 is a graph showing the frequency dependence of OW.

### DETAILED DESCRIPTION

In general, according to one embodiment, a microwave-assisted magnetic head includes a main magnetic pole configured to apply a recording magnetic field to a magnetic recording medium, an auxiliary magnetic pole configured to constitute a magnetic circuit together with the main magnetic pole, and a domain propagation element provided between the main magnetic pole and the auxiliary magnetic pole.

The domain propagation element includes a domain propagation path, a domain input portion configured to write a magnetic domain in the domain propagation path, and a current supply mechanism connected to the domain propagation path.

The domain propagation path has magnetic anisotropy perpendicular to a domain propagation direction and has two ends.

When the microwave-assisted magnetic head according to the embodiment is used, a high-frequency magnetic field can be generated by writing a magnetic domain in the domain propagation path and supplying a current to the domain propagation path to drive the magnetic domain in the domain propagation path. When the high-frequency magnetic field is superimposed on the recording magnetic field, magnetic recording can be performed.

At least part of the domain propagation path can have a linear shape. In addition, at least part of the domain propagation path can be arranged near the air bearing surface of the microwave-assisted magnetic head.

A DC current can be supplied to the domain propagation path from the current supply mechanism.

The domain propagation direction of the domain propagation path can include one of the off-track direction of the magnetic recording medium recordable by the microwave-assisted magnetic head and the film thickness direction of the magnetic recording medium.

The domain period of the domain propagation path can be 20 nm to 100 nm.

If the domain period is shorter than 20 nm, the high-frequency magnetic field intensity is insufficient, and a sufficient assist effect tends to be impossible to obtain. If the domain period exceeds 100 nm, the region where the assist effect is generated upon application of the high-frequency magnetic field becomes wide, and a high recording resolution tends to be hard to obtain.

When a practical magnetic recording medium is taken into consideration, the frequency of the high-frequency magnetic field can be 5 GHz to 40 GHz.

Outside the frequency range of the high-frequency magnetic field, a ferromagnetic resonance phenomenon cannot be induced in the recording medium, and the assist effect by application of the high-frequency magnetic field cannot be obtained.

A magnetic recording/reproducing apparatus according to an embodiment includes the microwave-assisted magnetic head.

An embodiment will now be described with reference to the accompanying drawings.

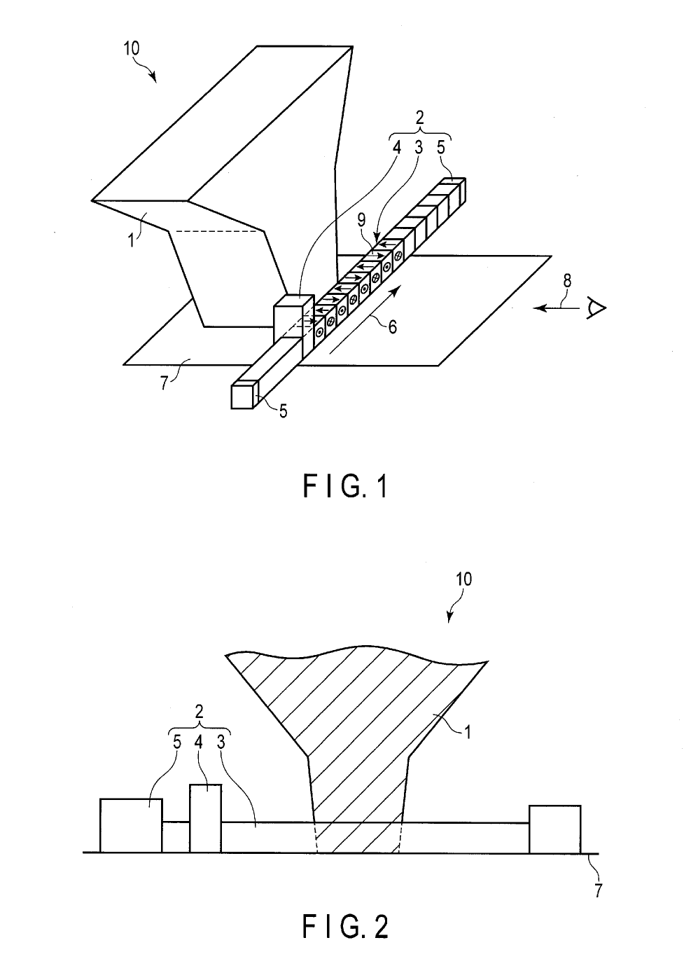

FIG. 1 is a perspective view showing a schematic structure of a microwave-assisted magnetic head according to an embodiment.

FIG. 2 is a view of the microwave-assisted magnetic head shown in FIG. 1 viewed from the down-track direction.

The down-track direction is indicated by an arrow 8.

As shown in FIG. 1, a microwave-assisted magnetic head 10 according to the embodiment includes a main magnetic pole 1 provided on an air bearing surface 7 that is an air bearing surface when the magnetic head is incorporated in a flying-type magnetic recording/reproducing apparatus, and a domain propagation element 2 similarly provided on the air bearing surface 7 and formed to pass near the air bearing surface 7 while inserting an insulating layer (not shown) between it and a trailing shield (not shown).

The domain propagation element 2 is an element configured to generate a high-frequency magnetic field using a domain propagation method, and includes a domain propagation path 3, a domain input portion 4, and electrodes 5 each serving as a current supply mechanism connected to the domain propagation path 3.

Here, to simplify the drawing, only the main magnetic pole 1 is illustrated as the magnetic pole of the microwave-assisted magnetic head 10. However, the basic magnetic head structure can further include an auxiliary magnetic pole (not shown) such as a trailing shield or a side shield that constitutes a magnetic circuit together with the main magnetic pole 1. The domain propagation path 3 is a member configured to generate a high-frequency magnetic field by internally forming a magnetic domain 9 and propagating it, and is made of a magnetic material having a thin line shape. A magnetic domain 9 formed in the domain propagation path 3 by the domain input portion 4 propagates in the lengthwise direction of the thin line, that is, a direction indicated by an arrow 6 by supplying a current from a signal source (not shown) via the electrode 5. This direction will be referred to as a domain propagation direction here. A DC current can be supplied to the electrode 5. In this embodiment, since an AC magnetic field can be generated using a DC current, as in a spin-torque oscillator, an AC current is not particularly necessary regarding the operation. In addition, the influence of the skin effect or the like need not be taken into consideration in DC current driving. Note that an electric circuit formed by including the domain propagation path 3 to propagate the magnetic domain 9 can include part of the microwave-assisted magnetic head 10. The direction of the current is determined to be the direction in which the magnetic domain 9 propagates from the domain input portion 4 to the vicinity of the main magnetic pole 1. Note that the shape of a section taken along a plane perpendicular to the lengthwise direction of the thin line is, for example, rectangular, circular, or elliptic. The axis of easy magnetization in the domain propagation path is given perpendicularly to the lengthwise direction of the thin line. Using the relationship between the magnetic anisotropy and the domain propagation direction makes it possible to do a stable operation even when the magnetic domain is formed in the domain propagation path 3 at a high density. Note that FIG. 1 shows an example in which the axis of easy magnetization in the domain propagation path 3 is added in the down-track direction. However, the present invention is not limited to this as long as the axis of easy magnetization is added in a direction perpendicular to the domain propagation direction. When the relationship between the domain propagation direction and the magnetic anisotropy of the magnetic domain is used, the change in the domain structure in the end of the domain propagation path becomes small, and a stable operation can be performed without using a special shape in the end.

For example, when the lengthwise direction of the thin line is formed in parallel to the off-track direction, as shown in FIG. 1, the easy axis of magnetic anisotropy is in the out-of-plane direction. This can make the magnetization direction perpendicular to the lengthwise direction of the thin line of the domain propagation path.

As the material of the domain propagation path, Co or CoPt in which the c-axis points in the out-of-plane direction, FePt, a Co/Ni stacked film, a Co/Pt stacked film, a Co/Pd stacked film, a TbFe layer, and the like are usable. Alternatively, an alloy that is made of a rare earth element and an iron group transition element and exhibits perpendicular magnetic anisotropy may be used as the material of the domain propagation path. Detailed examples are GdFe, GdCo, GdFeCo, TbFe, TbCo, TbFeCo, GdTbFe, GdTbCo, DyFe, DyCo, and DyFeCo.

A nonmagnetic element such as Ag, Cu, Au, Al, Mg, Si, Bi, Ta, B, C, O, N, Pd, Pt, Zr, Ir, W, Mo, Nb, or H can be added to these magnetic materials used in the domain propagation path. The magnetic characteristic can be adjusted by appropriately selecting the underlying layer. Various other physical properties such as the crystallinity, mechanical characteristic, and chemical characteristic can be adjusted. As the material of the underlying layer, Ru, Ti, Pt, Pd, MgO, Cr, Cu, Ta, and the like are usable.

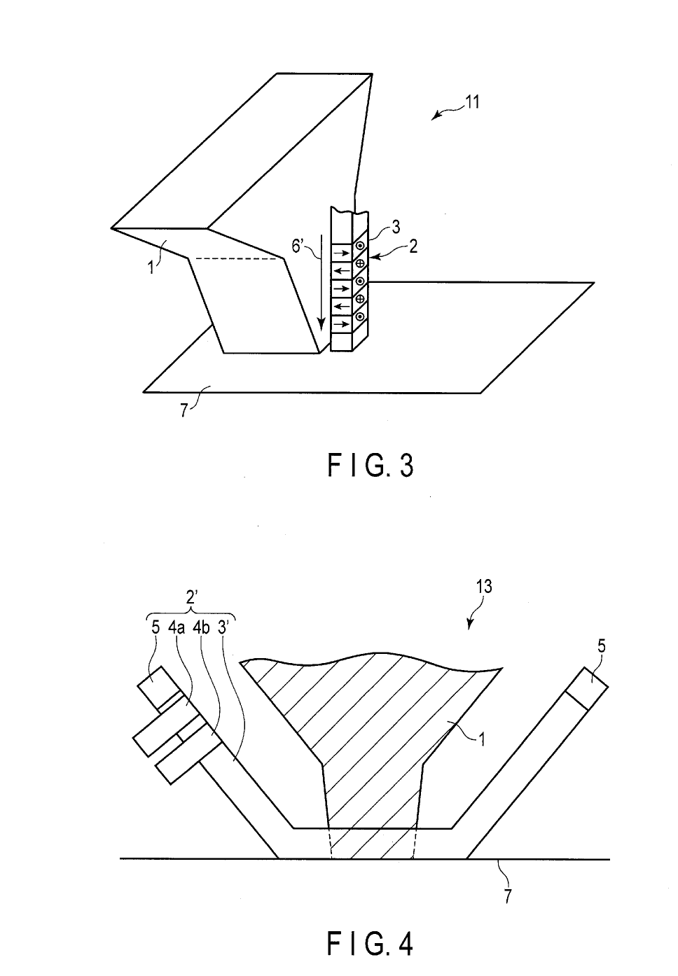

FIG. 3 is a perspective view showing another example of the schematic structure of the microwave-assisted magnetic head according to the embodiment.

A microwave-assisted magnetic head 11 has the same structure as in FIG. 1 except the arrangement of the domain propagation element 2. Note that although not illustrated, the domain input portion 4 is provided on the domain propagation path 3 on the upstream side of a domain propagation direction 6′ indicated by an arrow, and the electrodes 5 are provided at the two ends of the domain propagation path 3.

In the microwave-assisted magnetic head 10 or 11 according to the embodiment, the domain propagation path 3 is arranged such that at least part of it passes the trailing side of the main magnetic pole 1 near the air bearing surface 7. In FIG. 1, the domain propagation path 3 is arranged on the trailing side such that its lengthwise direction becomes the off-track direction with respect to magnetic recording medium near the main magnetic pole 1. However, for example, as shown in FIG. 3 the domain propagation path 3 can be arranged such that its lengthwise direction is set almost in the normal direction (domain propagation direction 6′) with respect to the air bearing surface of the medium. At this time, the lengthwise direction of the domain propagation path 3 is the film thickness direction of the magnetic recording medium.

In the embodiment, a high-frequency magnetic field having an equal intensity and frequency can be applied immediately under the domain propagation path. If the lengthwise direction of the domain propagation path is almost parallel to the down-track direction, the even high-frequency magnetic field is applied in the down-track direction. Hence, an almost even assist effect is generated along the line direction. For this reason, if the lengthwise direction of the domain propagation path is almost parallel to the down-track direction, it tends to be difficult to obtain an assist effect that can effectively improve the line recording density. From the same viewpoint, even if the lengthwise direction of the domain propagation path is parallel to the off-track direction, as shown in FIG. 1, the high-frequency magnetic field application region becomes wide when the domain propagation path is exposed in a wide range near the air bearing surface, and the track recording density tends to be hard to obtain. Hence, the length of the domain propagation path exposed near the air bearing surface can be almost the same as the width of the main magnetic pole, practically, for example, 100 nm or less or 20 to 100 nm. The domain propagation path need not always have a linear shape and can change its direction midway.

FIG. 4 is a view showing still another example of the schematic structure of the microwave-assisted magnetic head according to the embodiment.

As shown in FIG. 4, a microwave-assisted magnetic head 13 has the same structure as in FIG. 1 except that the domain propagation path 3 has its two ends raised in the height direction of the magnetic head 13.

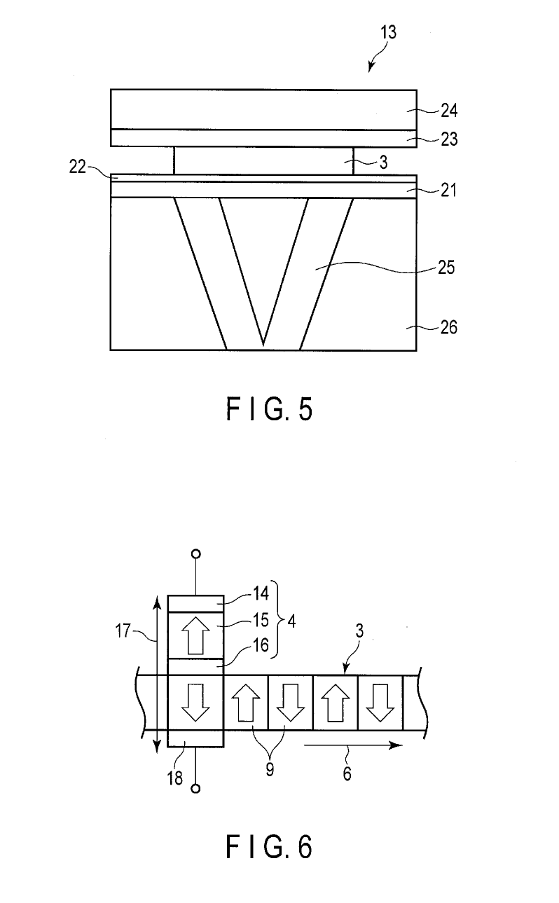

FIG. 5 is a view of the microwave-assisted magnetic head 13 having the structure shown in FIG. 4 viewed from the head air bearing surface.

As shown in FIG. 5, the microwave-assisted magnetic head 13 includes the main magnetic pole 1, an underlying layer 22 provided on an insulating layer 21 on the main magnetic pole 1, the domain propagation element 2 formed on the underlying layer 22, and shield structures such as a trailing shield 24 that is provided on an insulating layer 23 on the domain propagation element 2 and constitutes a magnetic circuit together with the main magnetic pole and side shields 26 provided on an insulating layer 25 on both sides of the main magnetic pole 1.

The domain propagation path can electrically be insulated from the main magnetic pole, magnetic shield, and the like near the off-track center ABS of the main magnetic pole from the domain input portion. This aims at suppressing an increase in the current supplied across the terminals caused by diversion of the current in this section. For this reason, the insulating layer, and as needed, the underlying layer used to control the alignment or magnetic characteristic of the domain propagation path, and the domain propagation path can sequentially be stacked on the main magnetic pole near the air bearing surface. If a magnetic shield that constitutes a magnetic circuit together with the main magnetic pole is formed on the trailing side, an insulating layer is further stacked, and a magnetic shield is formed on it. Even when part of the magnetic head is used as an electrode, the above-described structure can be used in the same section or position.

The propagation speed of the magnetic domain propagating in the domain propagation path used in the embodiment can be controlled by the density of a current supplied to the domain propagation path. In general, the frequency of the high-frequency magnetic field generated from the domain propagation element is determined by the propagation speed and the period of the magnetic domain.

A propagation speed v of the magnetic domain is given by

$$v = \frac{{μ}_{B} pi}{{eM}_{s}}$$

where μB is the Bohr magneton, p is the spin polarizability, i is the current density given to the domain propagation path, e is the charge amount of electrons, and Ms is saturation magnetization. Since μB and e are physical constants, and Ms and p are determined by the material used for the domain propagation path, the propagation speed v of the magnetic domain changes in proportion to the density of the current flowing to the domain propagation path.

At this time, if the period of the magnetic domain formed in the domain propagation path is 2, the frequency f of the high-frequency magnetic field generated from the domain propagation path is determined by

$$f = \frac{v}{λ} ∝ i$$

As described above, according to the embodiment, the frequency of the high-frequency magnetic field can be adjusted by the current density i so as to maximize the assist effect by the high-frequency magnetic field. On the other hand, the high-frequency magnetic field intensity depends on only the domain period and can therefore be controlled independently of the frequency by frequency control based on the current density.

The domain input portion is formed from, for example, an electromagnet. In this case, the magnetic domain is input to the domain propagation path by giving a magnetic field generated by the electromagnet to the domain propagation path. Note that when the magnetic domain is input by such an electromagnet, the domain input portion can be provided such that part of the magnetic head is included as the electromagnet. Domain input need not always be done by magnetic field application and can use a method using a spin-polarized current.

FIG. 6 is a view schematically showing an example of domain input to the domain propagation path.

For example, as shown in FIG. 6, the domain input portion 4 has a structure in which a nonmagnetic layer 16, a ferromagnetic layer 15 with a fixed magnetization direction, and an electrode 14 are stacked sequentially, and is connected to the domain propagation path 3. A counter electrode 18 is provided on the opposite side of the domain input portion 4 with respect to the domain propagation path 3. A signal source (not shown) is connected to the electrode 14, and a potential from the signal source is applied to the electrode 14 at the time of write. Electrons thus flow to the counter electrode 18 via the domain propagation path 3. The electrons flow from the ferromagnetic layer 15 toward the domain propagation path 3 and become an electron current spin-polarized in the magnetization direction of the ferromagnetic layer 15, as indicated by an arrow 17. The spin-polarized electron current gives the same magnetization direction as in the ferromagnetic layer 15 to the domain propagation path 3. At this time, the polarity of the magnetic domain in the domain propagation path 3 can be changed by changing the polarity of the external power supply (not shown).

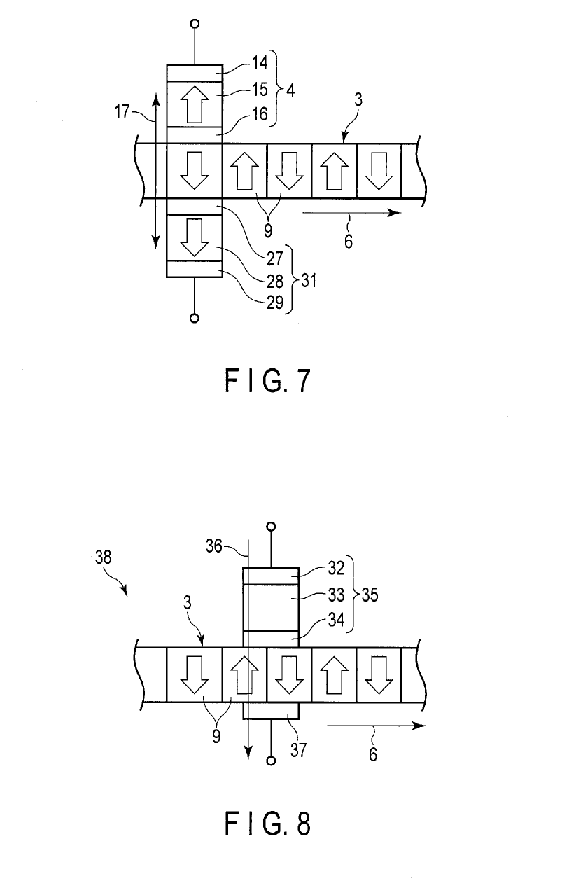

FIG. 7 is a view schematically showing another example of domain input to the domain propagation path.

The structure is the same as in FIG. 6 except that, for example, not the electrode 18 but a domain input portion 31 formed from a nonmagnetic layer 27, a ferromagnetic layer 28 with magnetization fixed in a direction reverse to that in the ferromagnetic layer 15 of the domain input portion 4, and an electrode 29 is provided on the opposite side with respect to the domain propagation path 3 as a modification, as shown in FIG. 7. A signal source (not shown) gives a potential difference between the electrodes 14 and 29 to integrally operate the domain input portions 4 and 31, thereby more efficiently generating the spin-polarized electron current. At this time, the magnetization direction in the domain propagation path 3 is the same as in the ferromagnetic material (15 or 28) that the electrons first pass through. Note that the domain propagation path 3 shown in FIG. 6 is provided with one domain input portion, and the domain propagation path 3 shown in FIG. 7 is provided with only one pair of domain input portions 4 and 31. However, the domain propagation path can include plural, for example, two domain input portions or two or more pairs of domain input portions. Note that the illustrated examples are merely examples, and domain input can be done using another method. A plurality of domain input portions can be provided in the domain propagation direction. In this case, the control frequency of the domain input portions can be lowered.

An element capable of detecting the domain period of the domain propagation path can further be provided near the domain propagation path of the domain propagation element.

FIG. 8 is a view schematically showing an example of a domain propagation element including an element capable of detecting a domain period.

For example, as shown in FIG. 8, a domain propagation element 38 includes the domain propagation path 3 and a domain size detection portion 35 provided on the domain propagation path 3. The domain size detection element 35 is a magnetoresistive element having a structure in which a nonmagnetic layer 34, a ferromagnetic layer 33 with a fixed magnetization direction, and an electrode 32 are stacked, and also including another electrode 37 to pass a current through the domain propagation path 3. This structure is similar to the domain input portion using a spin-polarized current. In the domain propagation element 38, the electrodes 32 and 37 can be provided in proximity because the domain size is detected by supplying a current between the electrodes 32 and 37 of the domain size detection portion via the domain propagation path 3.

When the magnetization direction in the domain propagation path 3 immediately under the domain size detection element 35 is the same (parallel) as the magnetization direction in the ferromagnetic layer 33, the resistance between the electrodes becomes low. On the other hand, when the magnetization direction in the domain propagation path immediately under the domain size detection element is different (antiparallel) from the magnetization direction in the ferromagnetic layer 33, the resistance between the electrodes becomes high. This resistance change reflects the average magnetization direction of each domain propagation path opposite to the reference layer. For this reason, the domain size can be detected by detecting the change in the magnetic resistance while propagating the magnetic domain and directly observing the peak value, the effectively value, and the signal waveform with respect to the time. A plurality of domain size detection elements may be provided. This can improve the detection accuracy and the detection size range.

For example, when performing detection by the peak value, the magnetoresistive element gives an output that is the average of domain states in the domain propagation path existing immediately under it. Hence, in principle, letting Lr be the length of the magnetoresistive element, a domain size within the range of 0.5×Lr to 1.0×Lr can be detected. However, if two or more magnetic domains exist immediately under the detection element, the domain size cannot be known definitely from the peak value. When a plurality of domain size detection elements are provided, and Lr is changed, the detection size range can easily be widened. Various magnetic materials as in the domain propagation path are usable as the ferromagnetic material of the domain input portion using a spin-polarized electron current and the domain size detection portion in the domain propagation element. To lower the write current at the time of domain input or increase the output of the domain size detection portion, a ferromagnetic material having a high spin polarizability can used. A high spin polarizability material called a half metal is an ideal material.

Examples of the half metal are a Heusler alloy, rutile oxide, spinel oxide, perovskite oxide, double perovskite oxide, zincblende chromium compound, pyrite manganese compound, and Sendust alloy. These materials can be inserted in part of the ferromagnetic layer of the domain input portion using a spin-polarized electron current and the domain size detection portion.

As a nonmagnetic layer, a thin film of a nonmagnetic metal or nonmagnetic insulating material is usable.

As the nonmagnetic metal, one material selected from the group consisting of Au, Cu, Cr, Zn, Ga, Nb, Mo, Ru, Pd, Ag, Hf, Ta, W, Pt, and Bi or an alloy containing one or more of the materials can be used. The thickness of the nonmagnetic layer needs to be set such that the static magnetic coupling between the reference layer and the domain propagation path becomes sufficiently small, and the thickness becomes smaller than the spin diffusion length of the nonmagnetic layer. More specifically, the thickness can be set within the range of 0.2 nm (inclusive) to 20 nm (inclusive).

To increase the magnetoresistive effect of the nonmagnetic insulating material, the nonmagnetic material can be caused to function as a tunnel barrier layer. In this case, as the nonmagnetic insulating material, Al₂O₃, SiO₂, MgO, AlN, Bi₂O₃, MgF₂, CaF₂, SrTiO₃, AlLaO₃, Al—N—O, Si—N—O nonmagnetic semiconductor, and the like are usable. As the nonmagnetic semiconductor, for example, ZnO, InMn, GaN, GaAs, TiO₂, Zn, and Te, or these materials doped with a transition metal are usable. These compounds need not have a perfectly stoichiometrically correct composition and can include defects or excess or deficiency of oxygen, nitrogen, or fluorine. The thickness of the nonmagnetic layer made of a nonmagnetic insulating material may be set within the range of, for example, 0.2 nm to 5 nm. If the nonmagnetic layer is an insulator, a pinhole may exist inside.

### (Simulations)

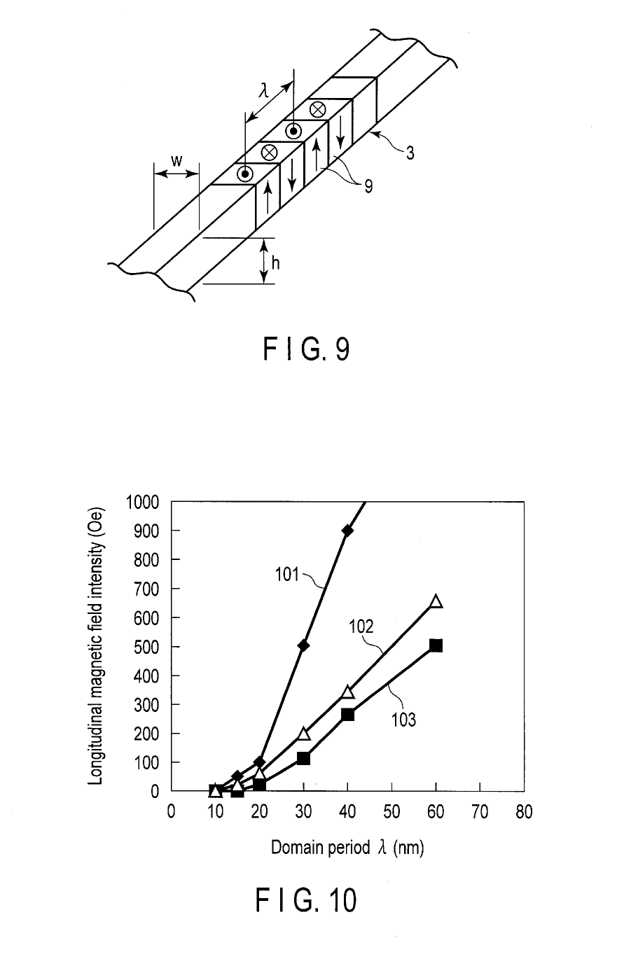

FIG. 9 is a view showing the outline of a domain propagation element used in simulations of the microwave-assisted magnetic head according to the embodiment.

Referring to FIG. 9, the domain period is represented by λ, the element width by w, and the element height by h.

Here, the domain propagation path 3 has a square sectional shape with respect to its lengthwise direction. The element width w=20 nm, and the element height h=20 nm. The length of the domain propagation path is 100 nm. Note that saturation magnetization in the domain propagation path is 1.4 T.

FIG. 10 is a graph showing the magnetic field intensity in the medium longitudinal direction when the magnetic period λ is changed.

In microwave assisted magnetic recording, high-frequency magnetic field components applied to a plane perpendicular to the axis of easy magnetization are known to be dominant in the assist effect. Here, magnetic field components corresponding to those are observed. Note that the observation point was set at a position apart from the head air bearing surface immediately under the domain propagation path by 13.0 nm toward the medium, and the simulations were conducted in the lengthwise direction and magnetization direction of each domain propagation path in correspondence with Table 1 below.

TABLE 1

| | | Direction of axis of |
|---|---|---|
| | | easy magnetization of |
| Graph | Thin line direction | domain propagation path |
| 101 | Cross-track direction | Magnetic head height direction |
| 102 | Cross-track direction | Down-track direction |
| 103 | Magnetic head height | Cross-track direction |
| | direction | or down-track direction |

Referring to FIG. 10, 101 represents a case where the domain propagation direction is set along the cross-track direction, and the axis of easy magnetization of the domain propagation path is set along the magnetic head height direction; 102, a case where the domain propagation direction is set along the cross-track direction, and the axis of easy magnetization of the domain propagation path is set along the down-track direction; and 103, a case where the domain propagation direction is set along the magnetic head height direction, and the axis of easy magnetization of the domain propagation path is set along the down-track or cross-track direction.

In all cases, when the domain period λ is 20 nm or less, the high-frequency magnetic field strength that contributes to the assist effect is almost zero. However, when λ>20 nm, the magnetic field intensity monotonically increases with respect to the domain period, as can be seen. This reveals that the domain propagation type high-frequency magnetic field generation element can has a domain period longer than at least 20 nm to obtain a good assist effect.

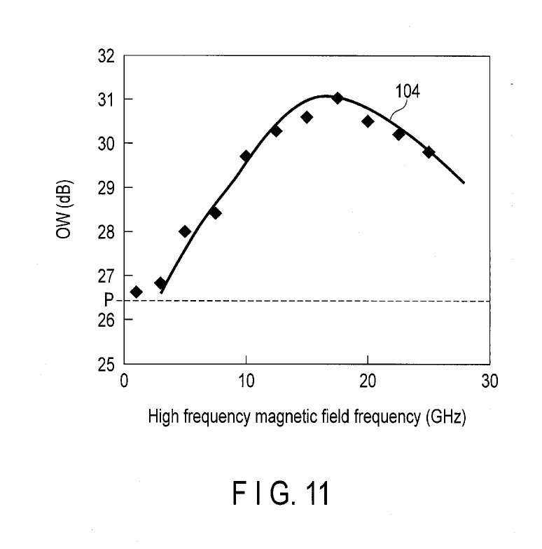

FIG. 11 is a graph showing the frequency dependence of an overwrite (OW) value.

The OW is a characteristic value representing the write capability of the magnetic head. In perpendicular magnetic recording, the OW is represented by the output attenuation factor of a high-frequency signal when a low-frequency signal is recorded on the high-frequency signal pattern, as indicated by

$$OW [ dB ] = 20 {log}_{10} \frac{signal a}{signal b}$$

where signal b of the denominator is the output value of the high-frequency signal when the high-frequency signal is recorded, signal a of the numerator is the residual output value of the high-frequency signal when a low-frequency signal is recorded on the high-frequency signal. TAA (Track Averaged Amplitude) is generally used as the output values. In this embodiment, an ideal 1000 kfci pattern (even in the track direction) is given as the high-frequency signal, and a 1000 kfci output signal under this condition is set as signal b. In addition, the 1000 kfci output signal when a 166 kfci pattern is recorded on the pattern by the recording head as a low-frequency signal is set as signal a, and its attenuation factor is defined as OW.

A graph 104 represents the frequency dependence of the OW value under the following conditions.

According to the embodiment, the magnetic recording medium used for the simulations was assumed to have an anisotropic magnetic field of 16 kOe, a medium saturation magnetization of 700 emu/cc, a damping constant of 0.03, and a rerecording layer thickness of 14 nm. The distance from the air bearing surface of the recording head to the center of the medium recording layer was set to 13 nm. Note that according to the embodiment, the OW value is obtained by the above-mentioned equation as the attenuation factor of a 1000 kfci signal when a signal of a much lower density is recorded on the ideal initial magnetization pattern of 1000 kfci.

The domain propagation direction near the main magnetic pole was set in the off-track direction, and the sectional area of the domain propagation path, the formed domain period, and the driving frequency were set to 20×20 nm², 30 nm, and 1 GHz to 25 GHz, respectively. Note that the distance from the trailing side surface of the magnetic recording head to the opposite domain propagation path surface was 10 nm.

In this case, an overwrite gain by the assist effect is obtained by applying a high-frequency magnetic field of 5 GHz or more, as is apparent. In addition, when the frequency is adjusted, the OW value is improved up to about 4.8 dB at maximum. This indicates that the intensity is improved by about 10% in terms of magnetic field intensity.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A microwave-assisted magnetic head comprising:
a main magnetic pole configured to apply a recording magnetic field to a magnetic recording medium;
an auxiliary magnetic pole configured to constitute a magnetic circuit together with the main magnetic pole; and
a domain propagation element including a domain propagation path having two ends and a magnetic anisotropy perpendicular to a domain propagation direction, and a domain input portion configured to write a magnetic domain in the domain propagation path, and a current supply mechanism connected to the domain propagation path, and at least part of the domain propagation path passes between the main magnetic pole and the auxiliary magnetic pole.

2. The head according to claim 1, wherein at least part of the domain propagation path has a linear shape and is arranged near an air bearing surface.

3. The head according to claim 1, wherein a DC current is supplied to the domain propagation path from the current supply mechanism.

4. The head according to claim 1, wherein the domain propagation direction includes one of an off-track direction and a medium film thickness direction.

5. The head according to claim 1, wherein a domain period of the domain propagation path is 20 nm to 100 nm, and a frequency of a high-frequency magnetic field is 5 GHz to 40 GHz.

6. The head according to claim 1, further comprising an element capable of detecting a domain period of the domain propagation path.

7. A magnetic recording/reproducing apparatus including a microwave-assisted magnetic head comprising:
a main magnetic pole configured to apply a recording magnetic field to a magnetic recording medium;
an auxiliary magnetic pole configured to constitute a magnetic circuit together with the main magnetic pole; and
a domain propagation element including a domain propagation path having two ends and a magnetic anisotropy perpendicular to a domain propagation direction, and a domain input portion configured to write a magnetic domain in the domain propagation path, and a current supply mechanism connected to the domain propagation path, and at least part of the domain propagation path passes between the main magnetic pole and the auxiliary magnetic pole.

8. The apparatus according to claim 7, wherein at least part of the domain propagation path has a linear shape and is arranged near an air bearing surface.

9. The apparatus according to claim 7, wherein a DC current is supplied to the domain propagation path from the current supply mechanism.

10. The apparatus according to claim 7, wherein the domain propagation direction includes one of an off-track direction and a medium film thickness direction.

11. The apparatus according to claim 7, wherein a domain period of the domain propagation path is 20 nm to 100 nm, and a frequency of a high-frequency magnetic field is 5 GHz to 40 GHz.

12. The apparatus according to claim 7, further comprising an element capable of detecting a domain period of the domain propagation path.
